(19) United States
(12) Patent Application Publication
(10) Pub. No.: US 2020/0366461 A1
(43) Pub. Date: Nov. 19, 2020

(54) ENCRYPTION METHOD AND APPARATUS OF VIDEO AND AUDIO SIGNAL STREAM

(71) Applicants: ThroughTek Technology (ShenZhen) Co., Ltd, Shenzhen (CN); ThroughTek Co., Ltd., Taipei City (TW)

(72) Inventor: Po-Yuan SHIH, Taipei City (TW)

(73) Assignees: ThroughTek Technology (ShenZhen) Co., Ltd, Shenzhen (CN); ThroughTek Co., Ltd., Taipei City (TW)

(21) Appl. No.: 16/872,449

(22) Filed: May 12, 2020

(30) Foreign Application Priority Data
May 14, 2019 (TW) 108116634

(51) Int. Cl. H04L 9/06; H04L 9/08; H04L 9/32

(52) U.S. Cl. CPC H04L 9/065; H04L 2209/34; H04L 9/3226; H04L 9/0869

(57) ABSTRACT

An encryption method of a video and audio signal stream comprises the steps of: providing a video and audio signal stream, wherein the video and audio signal stream comprises a header; generating a true key string and a false key string randomly, in which the true key string is associated with the header; encoding the true key string and the false key string to generate an encrypted string as the header of the audio signal, in which the encrypted string comprises an indication index indicating an initial position and a length of the true key string; and encoding the encrypted string and the video and audio signal stream to generate an encrypted video and audio signal stream.

### CROSS REFERENCE TO RELATED APPLICATION

This application claims the priority benefit of Taiwanese Patent Application Serial Number 108116634, filed on May 14, 2019, the full disclosure of which is incorporated herein by reference.

### BACKGROUND

### Technical Field

The present disclosure relates to an encryption method and apparatus, and more particularly to an encryption method and apparatus for video and audio signal stream.

### Related Art

Video and audio signals are generally converted into packets for transmission. Video and audio signals, for example, can be also converted into the format of packets through the digital container format. The form of packets can comprise file type information, headers, video and audio stacking data, and the end. However, while the signals are not encrypted, there would be security issues as they are easy to be stolen during transmission.

Some of the existing technologies could add encrypted data such as passwords in the process of converting video and audio signals into a packet format to encrypt the video and audio signals. However, since adding passwords is quite simple or regular to be cracked easily, it still causes security issues in the transmission of video and audio signals. Therefore, the encryption of video and audio signals still needs to be improved.

### SUMMARY

The present disclosure provides an encryption method and apparatus for video and audio signal stream to effectively protect the video and audio data in the video and audio signal stream.

The present disclosure provides an encryption method for video and audio signal stream comprising: providing a video and audio signal stream, wherein the video and audio signal stream comprises a header. Generating a true key string and a false key string randomly, wherein the true key string is associated with the header. Encoding the true key string and the false key string to generate an encrypted string as the header of the audio signal, wherein the encrypted string comprises an indication index indicating a starting position and a length of the true key string. Encoding the encrypted string and the video and audio signal stream to generate an encrypted video and audio signal stream.

The present disclosure provides an encryption apparatus for video and audio signal stream comprising: a video and audio unit providing a video and audio signal stream, wherein the video and audio signal stream comprises a header. A key generating unit randomly generating a true key string and a false key string, wherein the true key string is associated with the header. An encryption unit encoding the true key string and the false key string to generate an encrypted string as the header of the audio signal, wherein the encrypted string comprises an indication index indicating an initial position and a length of the true key string. A coding unit encoding the encrypted string and the video and audio signal stream to generate an encrypted video and audio signal stream.

The encryption method and apparatus for video and audio signal stream generate a true key string and a false key string randomly, wherein the true key string is associated with the header. The method and apparatus encode the true key string and the false key string to generate an encrypted string as the header of the audio signal, wherein the encrypted string comprises an indication index indicating an initial position and a length of the true key string. The method and apparatus encode the encrypted string and the video and audio signal stream to generate an encrypted video and audio signal stream. In this way, the video and audio data of the video and audio signal stream can be effectively protected.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a schematic diagram of an encryption apparatus for video and audio signal stream of one embodiment of the present disclosure;

FIG. 2 is another schematic diagram of an encryption apparatus for video and audio signal stream of one embodiment of the present disclosure;

FIG. 3 is a flow chart of an encryption method for video and audio signal stream of one embodiment of the present disclosure;

FIG. 4 is another flow chart of an encryption method for video and audio signal stream of one embodiment of the present disclosure; and

FIG. 5 is another flow chart of an encryption method other than that of FIG. 3 and FIG. 4 for video and audio signal stream of one embodiment of the present disclosure.

### DETAILED DESCRIPTION OF THE EMBODIMENTS

The present invention will now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that this present invention will be thorough and complete, and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only include these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals are used to refer to the same or similar elements throughout the invention.

In the following embodiments, the same or similar elements will be indicated by the same reference numerals.

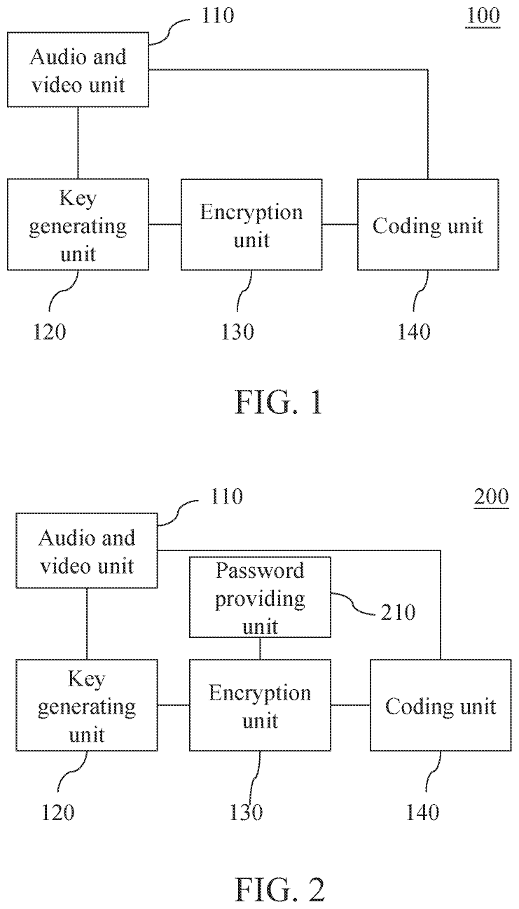

FIG. 1 is a schematic diagram of an encryption apparatus for video and audio signal stream of one embodiment of the present disclosure. The video and audio stream encryption apparatus 100 comprises a video and audio unit 110, a key generation unit 120, an encryption unit 130, and an encoding unit 140.

The video and audio unit 110 provides a video and audio signal stream for transmission and playback. The video and audio signal stream comprises a header, video and audio data and an end, wherein the header indicates the initial position of the video and audio material, the end indicates the end position of the video and audio material, and the video and audio data is between the header and the end.

The key generation unit 120 is coupled to the video and audio unit 110, and randomly generates a true key string and a false key string, wherein the true key string is associated with the header. That is, different true key string and false key string are generated by the key generation unit 120 every single time. Moreover, the true key string is associated with the header of the video and audio signal stream, so the header of the video and audio signal stream can be correspondingly found by obtaining the true key string. The false key string is a random number sequence protecting the true key string.

In this embodiment, the length of the true key string and the false key string are identical or different. It could be supposed that the true key string is “1010111”, the length is 7, the false key string is “00101000”, and the length is 8, but it is not used to limit the present disclosure.

The encryption unit 130 is coupled to the key generation unit 120 to encode the true key string and the false key string to generate an encrypted string to be the header of the video and audio signal. For example, after obtaining the true key string “1010111” and the false key string “00101000”, the encryption unit 130 encodes the true key string “1010111” and the false key string “00101000” with the preset algorithm to generate an encrypted string to be the header for video and audio signals

For example, the encryption unit 130 may arrange the false key string “00101000” before the true key string “1010111” such that the encrypted string encoded by the encryption unit 130 is “001010001010111”. Alternatively, the encryption unit 130 may split the false key string “00101000” and arrange it before and after the true key string “1010111”, such as “001010101111000”. In the foregoing, the false key string is split and arranged before and after the true key string that the first 4 digits of the false key string are arranged before the true key string, and the last 4 digits of the false key string are arranged after the true key string. The example is only an embodiment of the present disclosure and is not intended to limit the present disclosure. The manner in which the user adjusts the false key string before and after the true key string according to the needs thereof belongs to the implementation scope of the present invention. In this way, the true key string can be effectively protected.

Moreover, the encrypted string comprises an indication index indicating the start position of the true key string and the length of the string. That is, the user must obtain the index of the indication first in the encrypted string to know the initial position and the length of the string of the true key string in the encrypted string in order to obtain a valid true key string followed by finding the header of the correct video and audio stream. After finding the header of the correct video and audio stream, the user can effectively obtain the video and audio data of the video and audio stream for the subsequent decoding and playback operations.

The encoding unit 140 encodes the encrypted string and the video and audio signal stream to generate an encrypted video and audio signal stream. In this embodiment, the encrypted video and audio signal stream generated by the encoding unit 140 comprises an encrypted string with false key string, and the encrypted string is used as the header of the video and audio signal stream, therefore, when the encrypted video and audio signal stream is stolen, it is difficult to know the header of the correct video and audio signal stream without knowing the true key string, and the video and audio signal of the video and audio signal stream cannot be obtained. In this way, the video and audio data of the video and audio signal stream can be effectively protected.

Furthermore, the video and audio unit 110 provides a file type information, so that the encoding unit 140 could encode the file type information and the encrypted video and audio signal stream, in which the encrypted string is between the file type information and the header of the video and audio signal stream. Also, the file type information records the messages related to the encrypted video and audio signal stream, such as the video and audio data comprised in the encrypted video and audio signal stream is video data, audio data or video and audio data.

FIG. 2 is another schematic diagram of an encryption apparatus for video and audio signal stream of one embodiment of the present disclosure. The video and audio stream encryption apparatus 200 comprises a video and audio unit 110, a key generation unit 120, an encryption unit 130, an encoding unit 140, and a password providing unit 210. The connection relationship and operations between the video and audio unit 110, the key generation unit 120, the encryption unit 130, and the encoding unit 140 of the present embodiment is the identical or similar to the video and audio unit 110, the key generation unit 120, the encryption unit 130, and the coding unit 140 of FIG. 1. Thus, details of the embodiment could be referred to the description for FIG. 1, and further details would not be provided herein.

The password providing unit 210 provides a comparison password. Moreover, the comparison password can be set in advance by the user. Then, after the comparison password is provided, the encoding unit 140 may further encode the encrypted string and the comparison password to generate an encrypted string. The encoding unit 140 further encodes the encrypted string and the video and audio signal stream to generate an encrypted video and audio signal stream.

In this embodiment, the comparison password is associated with the indication index, and the comparison password is used to compare with the user password. That is, when the user needs to decrypt the encrypted video and audio signal stream, the user needs to input the user password through the user interface, for example. The decryption unit (not shown) would also compare the user password with the comparison password.

When the user password does not match the comparison password, it indicates that the user is not a legitimate user. The decryption unit would not be performing any decryption operation to effectively protect the video and audio signals in the encrypted video and audio signal stream. If the user password matches the comparison password, the user then is recognized as a legitimate user. The decryption unit would find the initial position and the length of the true key string according to the correlation between the matching password and the indication index to obtain the correct true key string. While obtaining the correct true key string, the decryption unit further obtains the header of the video and audio signal stream to obtain the video and audio signals in the video and audio signal stream for the subsequent decoding and playback operations. In this way, if the user password entered by the user matches the comparison password, adding the comparison password to the encrypted string could accelerate the decryption of the encrypted video and audio signal stream, thereby increasing the convenience of use.

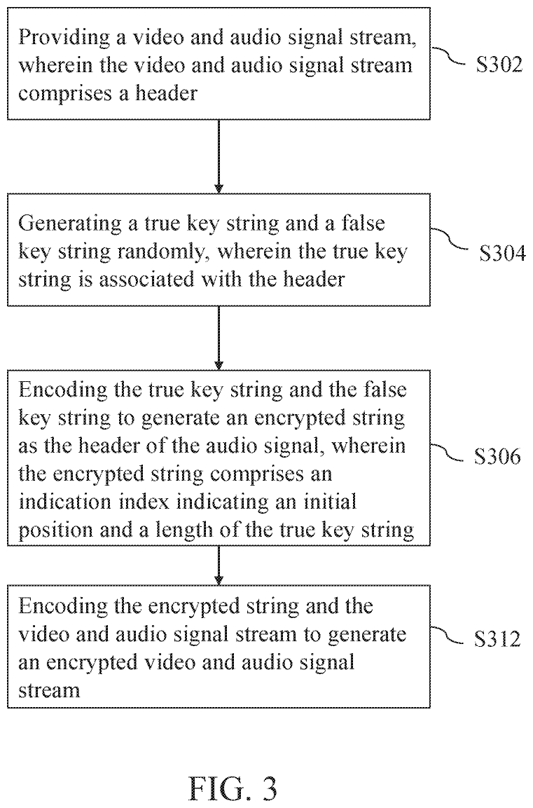

By the description of the above embodiments, an encryption method for video and audio signal streams can be summarized. FIG. 3 is a flow chart of an encryption method for video and audio signal stream of one embodiment of the present disclosure.

Step S302 provides a video and audio signal stream, in which the video and audio signal stream comprises a header. In step S304, a true key string and a false key string are randomly generated, in which the true key string is associated with the header. In step S306, the true key string and the false key string are encoded to generate an encrypted string to be a header of the video and audio signal in which the encrypted string comprises an indication index indicating the start position and the length of the true key string. In step S312, the encrypted string and the video and audio signal stream are encoded to generate an encrypted video and audio signal stream. In this embodiment, the length of the true key string is identical to or different from that of the false key string.

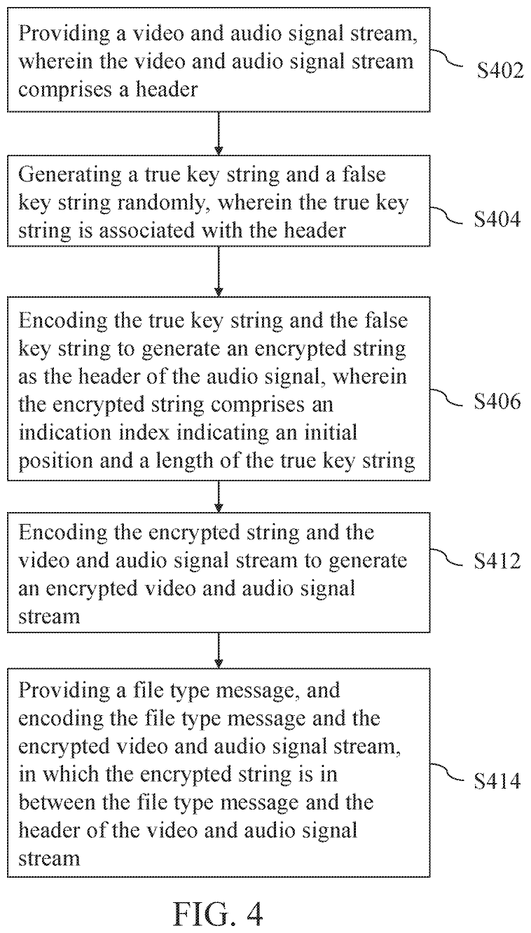

FIG. 4 is another flow chart of an encryption method for video and audio signal stream of one embodiment of the present disclosure. Step S402 provides a video and audio signal stream, in which the video and audio signal stream comprises a header. In step S404, a true key string and a false key string are randomly generated, in which the true key string is associated with the header. In step S406, the true key string and the false key string are encoded to generate an encrypted string to be a header of the video and audio signal in which the encrypted string comprises an indication index indicating the start position and the length of the true key string.

In step S412, the encrypted string and the video and audio signal stream are encoded to generate an encrypted video and audio signal stream. In step S414, a file type information is provided, and the file type information and the encrypted video and audio signal stream are encoded, in which the encrypted string is between the file type information and the header of the video and audio signal stream. In this embodiment, the length of the true key string is identical to or different from that of the false key string.

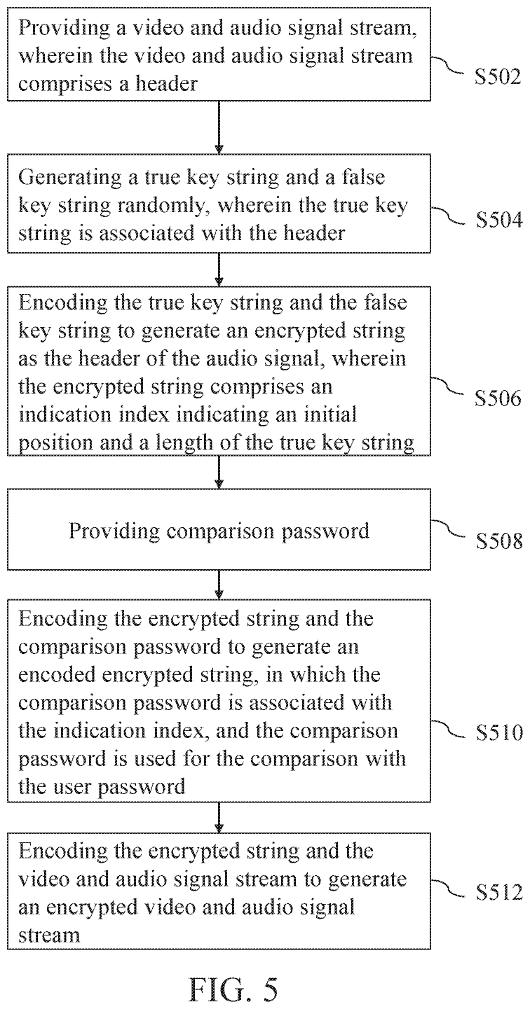

FIG. 5 is another flow chart of an encryption method other than that of FIG. 3 and FIG. 4 for video and audio signal stream of one embodiment of the present disclosure. Step S502 provides a video and audio signal stream, in which the video and audio signal stream comprises a header. In step S504, a true key string and a false key string are randomly generated, in which the true key string is associated with the header. In step S506, the true key string and the false key string are encoded to generate an encrypted string to be a header of the video and audio signal in which the encrypted string comprises an indication index indicating the start position and the length of the true key string.

The Step S508 provides a comparison password. In step S510, the encrypted string and the comparison password are encoded to generate an encoded encrypted string, in which the comparison password is associated with the indication index, and the comparison password is used for the comparison with the user password. In step S512, the encrypted string and the video and audio signal stream are encoded to generate an encrypted video and audio signal stream. In this embodiment, the length of the true key string is identical to or different from that of the false key string.

The encryption method and apparatus for video and audio signal stream provided by this embodiment generate a true key string and a false key string randomly, in which the true key string is associated with the header. The encryption method and apparatus encode the true key string and the false key string to generate an encrypted string as the header of the audio signal, in which the encrypted string comprises an indication index indicating an initial position and a length of the true key string. The encryption method and apparatus encode the encrypted string and the video and audio signal stream to generate an encrypted video and audio signal stream. In this way, the video and audio data of the video and audio signal stream can be effectively protected.

Moreover, a comparison password is provided, in which the encoding unit encodes the encrypted string and the comparison password to generate the encoded encrypted string. The apparatus then encodes the encrypted string and the video and audio signal stream to generate an encrypted video and audio signal stream, in which the comparison password is associated with the indication index, and the comparison password is used for the comparison with the user password. In this way, if the user password entered by the user matches the comparison password, adding the comparison password to the encrypted string could accelerate the decryption of the encrypted video and audio signal stream, thereby increasing the convenience of use.

It is to be understood that the term “comprises”, “comprising”, or any other variants thereof, is intended to encompass a non-exclusive inclusion, such that a process, method, article, or device of a series of elements not only include those elements but also includes other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. An encryption method of video and audio signal stream, comprising:
providing a video and audio signal stream, wherein the video and audio signal stream comprises a header;
generating a true key string and a false key string randomly, wherein the true key string is associated with the header;
encoding the true key string and the false key string to generate an encrypted string as the header of the audio signal, wherein the encrypted string comprises an indication index indicating an initial position and a length of the true key string; and
encoding the encrypted string and the video and audio signal stream to generate an encrypted video and audio signal stream.

2. The encryption method of video and audio signal stream according to claim 1, comprising:
providing a file type information and encoding the file type information and the encrypted video and audio signal stream, wherein the encrypted string is between the file type information and the header of the video and audio signal stream.

3. The encryption method of video and audio signal stream according to claim 1, wherein the length of the true key string is identical to or different from the length of the false key string.

4. The encryption method of video and audio signal stream according to claim 1, wherein after the step of encoding the true key string and the false key string to generate an encrypted string, the method comprises:
providing a comparison password;
encoding the encrypted string and the comparison password to generate the encoded encrypted string, wherein the comparison password is associated with the indication index; the comparison password is used for comparison with a user password.

5. An encryption apparatus of video and audio signal stream, comprising:
a video and audio unit providing a video and audio signal stream, wherein the video and audio signal stream comprises a header;
a key generating unit randomly generating a true key string and a false key string, wherein the true key string is associated with the header;
an encryption unit encoding the true key string and the false key string to generate an encrypted string as the header of the audio signal, wherein the encrypted string comprises an indication index indicating an initial position and a length of the true key string; and
a coding unit encoding the encrypted string and the video and audio signal stream to generate an encrypted video and audio signal stream.

6. The encryption apparatus of video and audio signal stream according to claim 5, wherein the video and audio unit provides a file type information; the coding unit encodes the file type information and the encrypted video and audio signal stream, wherein the encrypted string is between the file type information and the header of the video and audio signal stream.

7. The encryption apparatus of video and audio signal stream according to claim 5, wherein the length of the true key string is identical to or different from the length of the false key string.

8. The encryption apparatus of video and audio signal stream according to claim 5, comprising:
a password providing unit providing a comparison password;
wherein the encoding unit encodes the encrypted string and the comparison password to generate the encoded encrypted string; the comparison password is associated with the indication index; the comparison password is used for comparison with a user password.
